(19) United States
(12) Patent Application Publication
(10) Pub. No.: US 2002/0075467 A1
(43) Pub. Date: Jun. 20, 2002

(54) Exposure apparatus and method

(75) Inventors: Keiichi Tanaka, Funabashi-shi (JP); Mike Binnard, Belmont, CA (US)

Correspondence Address: OLIFF & BERRIDGE, PLC, P.O. BOX 19928, ALEXANDRIA, VA, 22320, US

(73) Assignee: NIKON CORPORATION

(21) Appl. No.: 09/739,772

(22) Filed: Dec. 20, 2000

(51) Int. Cl. G03B 27/42; G03B 27/62

(52) U.S. Cl. 355/57; 355/53; 355/77; 430/296; 430/30

(57) ABSTRACT

A predetermined pattern is transferred by applying an exposure beam while driving a stage by a driver so as to move an object along a moving plane. While the exposure beam is being applied, that is, during exposure, a counter stage is moved in a direction opposite from the moving direction of the stage in response to the movement of the stage, thereby substantially completely absorbing reaction force produced due to the driving of the stage. Accordingly, vibration and unbalanced load are not produced due to the driving of the stage, and precise exposure is possible. Furthermore, when the exposure beam is not applied, a correction device corrects the position of the counter stage so as to ensure that there is sufficient room (stroke) for the counter stage to move in a subsequent exposure operation. This makes it possible to shorten the stroke provided for the counter stage and to thereby prevent the apparatus from being of increased size.

### BACKGROUND OF THE INVENTION

1. Field of Invention

The present invention relates to an exposure apparatus and method, and more particularly to an exposure apparatus and method for transferring a pattern onto a substrate by irradiation of an exposure beam.

2. Description of Related Art

Various types of exposure apparatus are conventionally used in photolithographic processes for manufacturing semiconductor devices, liquid crystal display devices, and the like. In recent years, a step-and-repeat reduction projection exposure apparatus (a so-called “stepper”), a step-and-scan scan-exposure apparatus (a so-called “scanning stepper”), and the like have been widely used.

In these types of exposure apparatus, it is necessary to transfer a pattern formed on a reticle serving as a mask onto a plurality of shot areas of a substrate. For that purpose, a wafer (or substrate) stage is driven two-dimensionally in X and Y directions by a driving device including, for example, linear motors. Reaction forces produced due to driving of the wafer stage is mechanically caused to escape to the floor (the ground) by a frame member placed on a base (e.g., a floor surface or a base plate of the apparatus) which is vibration-isolated from the stage, as disclosed in, for example, U.S. Pat. No. 5,528,118.

In the case of the scanning stepper, a reticle stage as well as a wafer stage needs to be driven in a predetermined scanning direction by a linear motor or the like. In order to absorb reaction forces produced due to driving of the reticle stage, a countermass mechanism for one scanning direction, which functions based on the law of conservation of momentum, is typically adopted (see, for example, U.S. patent application Ser. No. 09/260,544). The reaction force produced due to driving of the reticle stage can also be mechanically transferred to the base, that is, the floor (the ground) by using a frame member (see, for example, U.S. Pat. No. 5,874,820).

In conventional projection exposure apparatus, the reaction force of the stage to be transferred to the base is damped by a vibration-isolating device, such as an anti-vibration table, so as to reduce vibration of a projection optical system (projection lens) and vibration of the stage transmitted via the base due to the reaction force. Although the reaction force is damped by being transferred to the base, a nontrivial amount of vibration, from the viewpoint of the level required under current micro-fabrication requirements, is given to the projection optical system and to the stage. Such vibration resulting from the reaction force deteriorates exposure accuracy of a scanning stepper that performs an exposure operation while scanning a stage (and a wafer or a reticle).

While transmission of reaction force can be substantially completely prevented by absorbing the reaction force by the countermass mechanism, the conventional countermass mechanism employs a countermass that moves in a direction opposite from the driving direction of a stage by a distance proportional to the driving distance of the stage. For this reason, the stroke of the countermass must be set in accordance with (in proportion to) the total stroke of the stage, which increases the size of the exposure apparatus.

### SUMMARY OF THE INVENTION

The invention has been made in view of the above circumstances, and it is one object of the invention to provide an exposure apparatus and method that allows precise exposure without increasing the size of the exposure apparatus.

According to a first aspect of the invention, there is provided an exposure apparatus for transferring a pattern by irradiation of an exposure beam while moving an object along a moving plane. The exposure apparatus includes a stage, a driver, a counter stage and a correction device. The stage holds the object. The driver drives the stage along the moving plane. At least a part of the driver is connected to the stage. The counter stage moves in a direction opposite from the moving direction of the stage in response to the movement of the stage. The correction device corrects the position of the counter stage when the exposure beam is not applied. At least a part of the correction device is connected to the counter stage.

The counter stage moves in response to the movement of the stage and serves to avoid an unbalanced load by preventing displacement of the center of gravity of a dynamic system including the stage and the counter stage. The counter stage includes a stage that is different from the stage for holding the object and is driven so that the total momentum of both the stages is maintained constant. The counter stage also includes, for example, a stationary member of the driver that generates driving force for the stage that holds the object, in cooperation with a moving member of the driver that moves together with the stage. In this case, the stationary member of the driver is freely moved by reaction force against the driving force for the stage.

In the above exposure apparatus, a predetermined pattern is transferred by irradiating an exposure beam while driving the stage by the driver so as to move the object along the moving plane together with the stage. While the exposure beam is applied, that is, during an exposure operation, the counter stage is moved in a direction opposite from the moving direction of the stage, thereby absorbing most of reaction force generated due to the driving of the stage. This allows precise exposure.

When vibration resulting from the reaction force due to driving of the stage does not have any adverse effect on exposure accuracy, that is, when the exposure beam is not applied, the correction device appropriately corrects the position of the counter stage, for example, so as to ensure that there is sufficient space for the stroke (movement) of the counter stage in a subsequent exposure operation. This makes it possible to shorten the total stroke provided for the counter stage and to thereby prevent the apparatus from being of increased size. In other words, the total stroke for the counter stage is less than the total stroke for the stage that holds the object. The total stroke for the counter stage only needs to be long enough to compensate for the stroke required for the object stage to perform an exposure operation on one exposure area or row/column of exposure areas.

Preferably, the object is a substrate onto which the pattern is transferred, and the stage is a substrate stage. This makes it possible to improve exposure accuracy of a scan-exposure apparatus, in which a substrate stage must be driven during an exposure operation and the total stroke of the substrate stage is long, without increasing the size of the apparatus.

The exposure apparatus may have a plurality of substrate stages. In this case, substrates held by the substrate stages can be exposed with improved throughput by concurrently performing an exposure operation and an exposure preparation operation or concurrently subjecting the plurality of substrates to exposure.

Preferably, the driver has a moving member connected to the stage and a stationary member cooperating with the moving member. Herein, “cooperating” means any interaction (for example, a physical interaction or an electromagnetic interaction) between the stationary member and the moving member for the purpose of driving the stage along the moving plane. In this specification, the term “cooperating” is used as a generic term for such interaction between the stationary member and the moving member to generate driving force.

The counter stage may include the stationary member of the driver. In such a case, since the stationary member, which is a component of the driver, also functions as a counter stage, it is unnecessary to provide another structure separate from the stage holding the object and the driver. This efficiently prevents the apparatus from being of increased size.

Preferably, the driving force, the center of gravity of the moving member, and the center of gravity of the stationary member are identical to each other in position in the direction of the normal to the moving plane. Since the point of action of the driving force acting on the moving member is the same as the point of action of the reaction force acting on the stationary member, and since the center of gravity of the stationary member is identical in position in the direction of the normal to the moving plane, rotational force about the center of gravity of the stationary member is not produced by reaction force due to driving of the moving member. Therefore, the moving member and the stationary member move only along the moving plane, and precise position control is possible.

The driver may include a first driver for driving the stage in a first direction and a second driver for driving the stage in a second direction orthogonal to the first direction. In this case, the stage is allowed to be driven in arbitrary two-dimensional directions.

Preferably, the first object is a substrate onto which the pattern is transferred, and the substrate has a plurality of exposure areas arranged in a matrix, onto each of which the pattern is transferred. In this case, the correction device corrects the position of the counter stage between the completion of exposure of an n-th row (n is a natural number), which is nearly parallel with the second direction, and the start of exposure of an (n+1)-th row. For example, after transfer of the pattern onto the exposure areas in the n-th row, which is nearly parallel with the second direction, among the exposure areas arranged on the substrate in a matrix, is completed, the correction device corrects the position of the counter stage during a linefeed operation from the n-th row to the (n+l)-th row, thereby ensuring a stroke necessary for the counter stage to move in an exposure operation for the (n+l)-th row. Since the position of the counter stage is corrected during the linefeed operation in which exposure is suspended for a relatively long time period, there is little residual vibration at the start of a scan-exposure operation after the linefeed operation. This prevents vibration from being produced due to driving of the substrate stage during exposure. Furthermore, since the moving distance per unit time can be shortened, it is possible to reduce driving force for the counter stage and to thereby minimize vibration due to driving of the counter stage from being transmitted to other sections of the exposure apparatus.

The object may be a mask with the pattern formed thereon, and the stage may be a mask stage. In this case, since reaction force produced due to driving of the mask stage is absorbed by movement of the counter stage, it is possible to reduce vibration from being transmitted to other sections of the exposure apparatus. Furthermore, since the position of the counter stage is corrected while the exposure beam is not being applied, exposure accuracy will not be affected by driving of the counter stage. This makes it possible to shorten the stroke of the counter stage without deteriorating exposure accuracy, and to thereby prevent the exposure apparatus from being of increased size.

The mask stage may have a holding section for holding a plurality of masks. This makes it possible to precisely and efficiently perform, for example, so-called double exposure and triple exposure or stitching.

According to a second aspect of the invention, there is provided an exposure method for transferring a pattern by irradiation of an exposure beam while moving an object held on a stage along a moving plane. The exposure method includes the steps of: driving the stage along the moving plane, moving a countermass in a direction opposite from the moving direction of the stage in response to the movement of the stage, and correcting the position of the countermass while the exposure beam is not applied.

The “countermass” is a member that moves in response to movement of the stage, and serves to prevent the center of gravity of a dynamic system including the stage and the countermass from being displaced and to thereby avoid an unbalanced load. The countermass includes a stage that is different from the stage for holding the object to be moved, and is driven so that the total momentum of both the stages is maintained constant. The countermass also includes, for example, a stationary member of a driver that generates driving force for the stage for holding the object to be moved, in cooperation with a moving member of the driver that moves together with the stage. The stationary member is freely moved by reaction force against the driving force for the stage.

When an exposure beam is applied, that is, during an exposure operation, the stage for holding the object is moved along the moving plane and the countermass is moved in a direction opposite from the moving direction of the stage in response to the movement of the stage. Since reaction force produced due to driving of the stage is absorbed by the movement of the countermass, vibration is reduced and precise exposure is possible. The position of the countermass is corrected while the exposure beam is not applied. For this reason, it is possible to shorten the stroke of the countermass without deteriorating exposure accuracy. In this case, the object may be a substrate onto which the pattern is transferred.

The stage may be driven by a driver including a moving member connected to the stage and a stationary member that cooperates with the moving member. In this case, the countermass may be the stationary member. The point of action of the driving force, the center of gravity of the moving member, and the center of gravity of the stationary member may be identical to each other in position in the direction of the normal to the moving plane.

The stage may be movable in a first direction and in a second direction orthogonal to the first direction. In this case, the stage is allowed to be moved in arbitrary two-dimensional directions. Preferably, the first object is a substrate onto which the pattern is transferred, the substrate has a plurality of exposure areas arranged in a matrix, onto each of which the pattern is transferred, and the position of the counter stage is corrected between the completion of exposure of an n-th row (n is a natural number), which is nearly parallel with the second direction, and the start of exposure of an (n+1)-th row.

The object may be a mask with the pattern formed thereon.

The countermass may be moved in a direction opposite from the moving direction of the stage by reaction force produced when the stage is moved. This eliminates the necessity for another driving device for moving the countermass and allows reaction force to be automatically absorbed.

### BRIEF DESCRIPTION OF THE DRAWINGS

The invention will be described in conjunction with the following drawings in which like reference numerals designate like elements and wherein:

FIG. 1 is a schematic view showing the configuration of an exposure apparatus according to an embodiment of the invention;

FIG. 2 is a perspective view of a wafer stage assembly shown in FIG. 1;

FIG. 3 is a partly broken view of a wafer stage and a wafer driving device shown in FIG. 2;

FIG. 4A is a cross-sectional view, taken along line D-D in FIG. 2;

FIG. 4B is an explanatory view of an X-axis stationary member and a frame shown in FIG. 2, as viewed from the +-X-axis direction;

FIG. 5 is a partly broken view of an X-axis moving member shown in FIG. 3, in which the X-axis stationary member is omitted;

FIG. 6 is an explanatory view of an X restraint mechanism;

FIG. 7 is an explanatory view showing the positions of the centers of gravity of the wafer stage and the wafer driver;

FIG. 8 is an explanatory view illustrating an exposure process for a wafer;

FIG. 9 is a schematic structural view of an exposure apparatus according to a modification of the first embodiment; and

FIG. 10 is an explanatory view of a wafer stage assembly shown in FIG. 9.

### DETAILED DESCRIPTION OF PREFERRED EMBODIMENTS

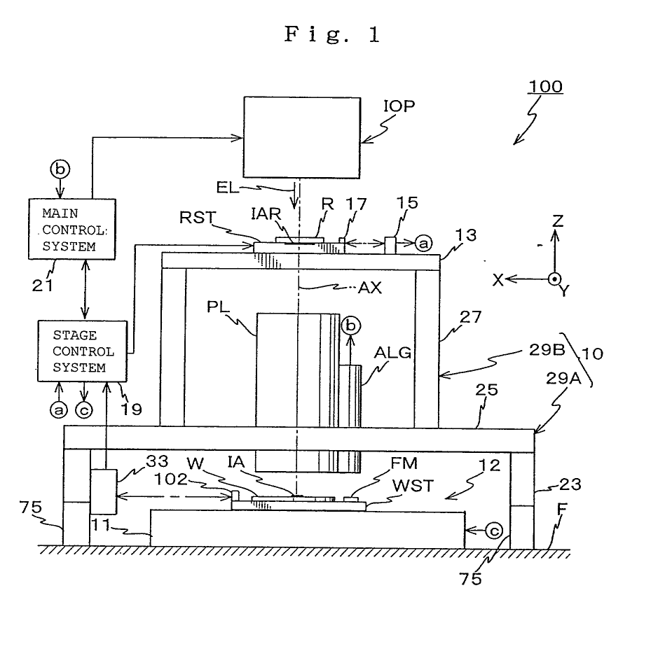

An embodiment of the invention will be described below with reference to FIGS. 1 to 8.

FIG. 1 shows the general configuration of an exposure apparatus 100 according to an embodiment of the present invention. The exposure apparatus 100 is a scan-exposure apparatus of a step-and-scan type, that is, a so-called scanning stepper. As will be described later, the exposure apparatus 100 of this embodiment includes a projection optical system PL. In the following description: (a) the direction of the optical axis AX of the projection optical system PL is designated a Z-axis direction; (b) the direction in which a reticle R serving as a mask, and a wafer W serving as a substrate, are relatively scanned in a plane orthogonal to the Z-axis direction is designated a Y-axis direction; and (c) the direction orthogonal to the Z-axis and Y-axis directions is designated an X-axis direction. Additionally, the reticle and the wafer are generically referred to as “object”.

The exposure apparatus 100 includes an illumination system IOP, a reticle stage RST serving as a mask stage for holding a reticle R, the projection optical system PL, a wafer stage assembly 12 composed of a wafer stage WST serving as a substrate stage for holding a wafer W and a wafer driving unit 11 for two-dimensionally driving the wafer stage WST in the X and Y directions, a control system for the devices, and the like.

As disclosed in, for example, Japanese Laid-Open Patent Application Publication Nos. 9-320956 and 4-196513 and U.S. Pat. No. 5,473,410 corresponding thereto, the illumination system IOP includes a light-source unit, a shutter, a secondary light-source forming optical system (optical integrator), a beam splitter, a light-collecting lens system, a reticle blind, an imaging lens system, and the like (all not shown). The IOP emits illumination light EL for exposure (hereinafter simply referred to “exposure light”) serving as an exposure beam having a substantially uniform illumination distribution. The exposure light EL illuminates a rectangular (or arcuate) illumination area IAR on a reticle R at uniform illuminance. Used as the exposure light EL is, for example, ultraviolet bright lines (g-rays and i-rays) from an extra-high pressure mercury lamp, or far-ultraviolet or vacuum ultraviolet light such as KrF excimer laser light (with a wavelength of 248 nm), ArF excimer laser light (with a wavelength of 193 nm), and F₂ laser light (with a wavelength of 157 nm).

The reticle stage RST is placed on a top plate 13 of a second column 29B constituting a main column 10, which will be described later. The top plate 13 also functions as a reticle base. Hereinafter, the top plate 13 will also be referred to as a “reticle base 13”.

A reticle R is fixed on the reticle stage RST by, for example, vacuum suction. In order to position the reticle R, the reticle stage RST is capable of two-dimensional micromotion (in the X-axis direction, the Y-axis direction orthogonal thereto, and the direction of rotation about the Z-axis direction orthogonal to the XY plane) in a plane perpendicular to the Z-axis.

The reticle stage RST can also be moved on the reticle base 13 at a designated scanning speed in a predetermined scanning direction (in the Y-axis direction in this embodiment) by a reticle driving section (not shown) serving as a driving device having a linear motor and the like. The stroke of the reticle stage RST is set so that the entire surface of the reticle R can cross at least the optical axis of the illumination system IOP.

A movable mirror 17 is fixed on the reticle stage RST so as to reflect a laser beam from a reticle laser interferometer (hereinafter referred to as a “reticle interferometer”) 15. The position of the reticle stage RST in a stage moving plane is constantly detected by the reticle interferometer 15 with a resolution of, for example, approximately 0.5 nm to 1 nm. In reality, and as is known in the art, a movable mirror having a reflecting surface orthogonal to the scanning direction (Y-axis direction) and a movable mirror having a reflecting surface orthogonal to the non-scanning direction (X-axis direction) are disposed on the reticle stage RST, and one reticle interferometer is disposed in the scanning direction and two reticle interferometers are disposed in the non-scanning direction. In FIG. 1, the mirrors are represented by the movable mirror 17 and the interferometers are represented by the reticle interferometer 15.

Positional information (or speed information) about the reticle stage RST from the reticle interferometer 15 is sent to a main control system 21 via a stage control system 19. The stage control system 19 drives the reticle stage RST via the reticle driving section (not shown) based on the positional information about the reticle stage RST according to directions from the main control system 21.

A pair of reticle alignment systems (not shown) is placed above the reticle R. The reticle alignment systems each include an epi-illumination system for illuminating a mark to be detected with illumination light having the same wavelength as that of the exposure light EL, and a reticle alignment microscope for picking up an image of the mark to be detected. The reticle alignment microscope includes an imaging optical system and an image pickup device. The result of image pickup by the reticle alignment microscope is supplied to the main control system 21.

The above-described main column 10 includes a first column 29A placed on a floor F of a clean room via a plurality of vibration-isolating units 75, and the second column 29B placed on the first column 29A.

The first column 29A is composed of a plurality of column supports 23 placed in line at the tops of the respective vibration-isolating units 75, and a barrel surface plate 25 horizontally supported by the column supports 23. In this case, microvibrations to be transmitted from the floor F to the main column 10 including the barrel surface plate 25 are isolated by the vibration-isolating units 75 on the microgravity level.

The second column 29B is composed of a plurality of leg portions 27 embedded in the upper surface of the first column 29A, and the above-described top plate (reticle base) 13 horizontally supported by the leg portions 27.

The projection optical system PL is inserted from above through an opening (not shown) formed in the center of the barrel surface plate 25, and is supported by the barrel surface plate 25 via a flange (not shown) formed at about the center of a barrel thereof in the height direction. In this embodiment, the projection optical system PL is a refracting optical system that is formed of a double-sided telecentric reduction system composed of a plurality of lens elements arranged at predetermined intervals along the optical-axis direction AX (the Z-axis direction). The projection optical system PL may be a reduction system that is one-sided telecentric (for example, telecentric only on the side of the wafer stage WST). The projection magnification of the projection optical system PL is set at, for example, ¼, ⅕, or ⅙. For this reason, when the illumination area IAR on the reticle R is illuminated with illumination light from the illumination optical system IOP, a reduced image (partial inverted image) of a circuit pattern in the illumination area IAR of the reticle R is formed on an exposure area IA of a wafer W having a photoresist applied on its surface, which is conjugate with the illumination area IAR, via the projection optical system PL by the illumination light passed through the reticle R.

Adjacent to the projection optical system PL, an off-axis alignment microscope ALG is placed. The alignment microscope ALG includes three types of alignment sensors, an LSA (Laser Step Alignment) type, an FIA (Field Image Alignment) type, and an LIA (Laser Interferometric Alignment) type, and can measure the positions in the X and Y two-dimensional directions of a fiducial mark on a fiducial mark plate and an alignment mark on the wafer.

In this embodiment, the three types of alignment sensors are used depending on the operation, such as so-called search alignment for detecting the positions of a predetermined number of search alignment marks on the wafer W so as to measure the general position of the wafer W, and fine alignment for detecting the positions of a predetermined number of fine alignment marks on the wafer W so as to exactly measure the positions of shot areas.

Digitized wave signals, which are obtained by converting information from the alignment sensors constituting the alignment microscope ALG from analog to digital by an alignment control device (not shown), are subjected to computation, and the mark positions are thereby detected. The detection result is transmitted to the main control system 21.

The exposure apparatus 100 of this embodiment further includes a multipoint focal position detecting system serving as one of oblique-incidence type focus detecting systems for detecting the positions of the exposure area IA and the adjacent area in the Z-axis direction (the optical axis direction AX) on the wafer W. The multipoint focal position detecting system is composed of a light-emitting optical system and a light-receiving optical system that are not shown, and has a structure similar to that disclosed in, for example, Japanese Laid-Open Patent Application Publication No. 6-283403 and U.S. Pat. No. 5,448,332 corresponding thereto.

The above-described wafer stage assembly 12 is placed below the projection optical system PL. The wafer stage assembly 12 is composed of the wafer stage WST for holding a wafer W and the wafer driving unit 11 serving as a driving device.

A wafer W is fixed on the upper surface of the wafer stage WST via a wafer holder (not shown) by electrostatic suction or vacuum suction. A fiducial mark plate FM is also fixed on the wafer stage WST. The fiducial mark plate FM has various fiducial marks for base line measurement for measuring the distance from the center of detection of the alignment microscope ALG to the optical axis of the projection optical system PL.

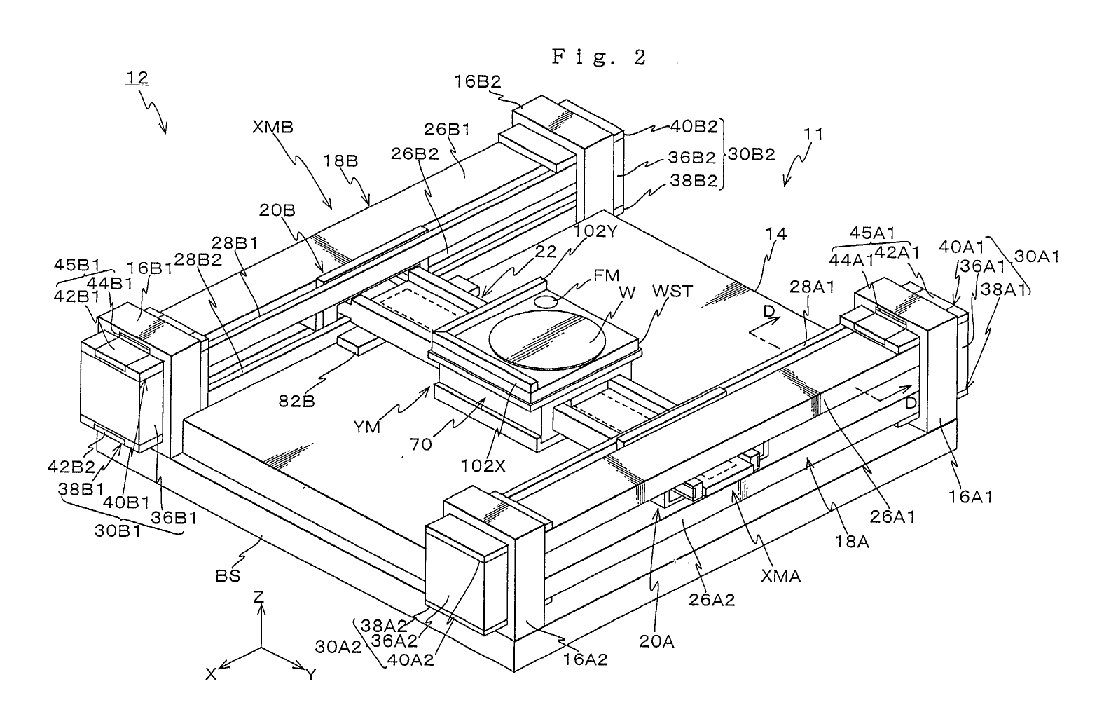

On the upper surface of the wafer stage WST, as shown in FIG. 2, an X movable mirror 102X is disposed at one end in the X-axis direction (a +X-side end), and extends in the Y-axis direction, and a Y movable mirror 102Y is disposed at one end in the Y-axis direction (a −Y-side end), and extends in the X-axis direction. The outer surfaces of the movable mirrors 102X and 102Y are mirror-finished reflecting surfaces. In FIG. 1, the movable mirrors 102X and 102Y are represented by a movable mirror 102.

An X-axis interferometer and a Y-axis interferometer (not shown) are placed opposed to the reflecting surfaces of the movable mirrors 102X and 102Y. Interferometric beams from the X-axis and Y-axis interferometers are projected onto the reflecting surfaces of the movable mirrors 102X and 102Y, and the reflected beams from the reflecting surfaces are received by the respective interferometers. The amounts of displacement of the reflecting surfaces of the movable mirrors from the reference positions are thereby measured, so that the two-dimensional position of the wafer stage WST is detected. In FIG. 1, the X-axis interferometer and the Y-axis interferometer are represented by a wafer interferometer 33.

The wafer driving unit 11 will now be described in detail with reference to FIGS. 2 to 7.

Referring to FIG. 2, the wafer driving unit 11 includes: (a) a Y-axis linear motor device (hereinafter referred to as a “Y-axis motor device”) YM serving as a first driving device (or as a second driving device) for driving the wafer stage WST on a wafer surface plate 14 in the Y-axis direction, and (b) a first X-axis linear motor device (hereinafter referred to as a “first X-axis motor device”) XMA and a second X-axis linear motor device (hereinafter referred to as a “second X-axis motor device”) XMB serving as a second driving device (or as a first driving device) for moving the wafer stage WST and the Y-axis motor device YM on the wafer surface plate 14 in the X-axis direction.

The first X-axis motor device XMA (more specifically, an X-axis stationary member 18A which will be described later) is supported in a non-contact manner by frames 16A1 and 16A2 fixed on the upper surfaces of two comers of a wafer base BS on the +Y-direction side so that it is restrained in the Y-axis direction and the Z-axis direction. The second X-axis motor device XMB (more specifically, an X-axis stationary member 18B which will be described later) is similarly supported in a non-contact manner by frames 16B1 and 16B2 fixed on the upper surfaces of two comers of the wafer base BS on the −Y-direction side so that it is restrained in the Y-axis direction and the Z-axis direction.

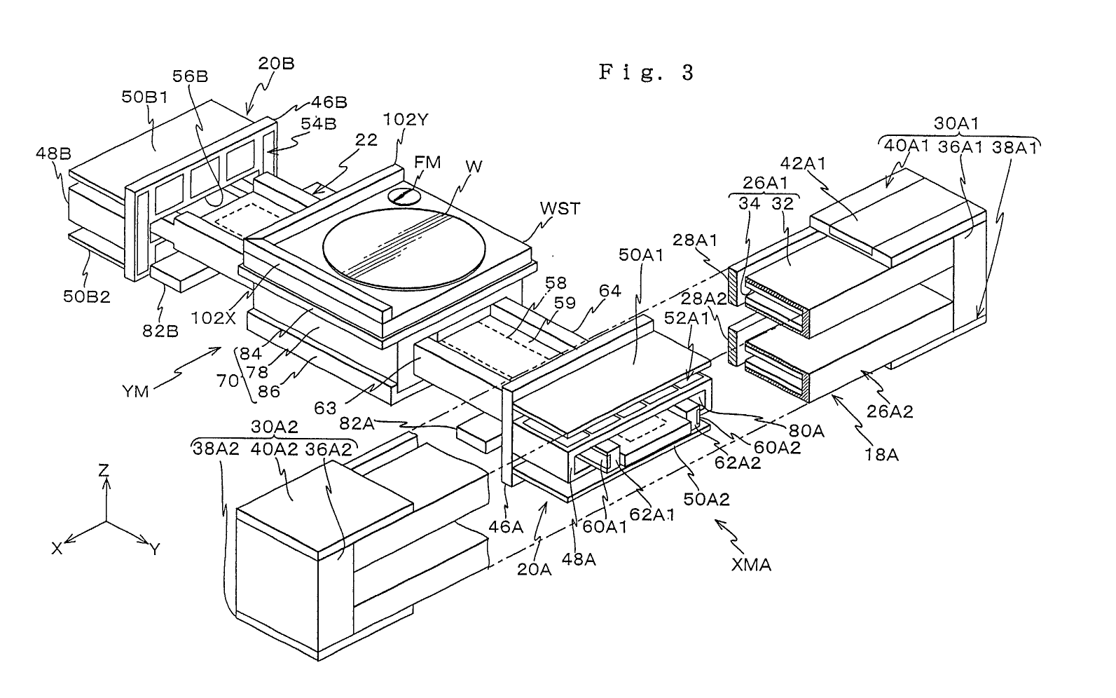

The first X-axis motor device XMA includes the X-axis stationary member 18A and an X-axis moving member 20A that moves in the X-axis direction along the X-axis stationary member 18A in engagement therewith, as shown in FIG. 2 and in FIG. 3, which is a partially broken view of the wafer stage WST and a part of the wafer driving device shown in FIG. 2.

The X-axis stationary member 18A includes: (i) a magnetic pole unit 26A1 of U-shaped YZ-plane cross section that extends in the X-axis direction, (ii) a magnetic pole unit 26A2 disposed on the −Z side (lower side) of the magnetic pole unit 26A1 and having a structure similar to that of the magnetic pole unit 26A1, (iii) platelike X-axis guide members 28A1 and 28A2 respectively disposed on the −Y-sides of the magnetic pole units 26A1 and 26A2 so as to extend in the X-axis direction, and (iv) holding members 30A1 and 30A2 for holding the magnetic pole units 26A1 and 26A2 and the X-axis guide members 28A1 and 28A2 in a predetermined positional relationship.

As shown in FIG. 3, the magnetic pole unit 26A1 includes a yoke 32 of U-shaped cross section, and a plurality of field magnets 34 arranged on the upper and lower opposing surfaces of the yoke 32 at predetermined intervals in the X-axis direction. Since the pole faces of the field magnets 34 opposing in the Z-axis direction are opposite in polarity, Z-axis direction magnetic flux is mainly generated between the opposing field magnets 34. Since the pole faces of the field magnets 34 that are adjacent to each other in the X-axis direction are opposite in polarity, an alternating magnetic field is formed in the X-axis direction in a space inside the yoke 32.

The magnetic pole unit 26A2 has a structure similar to that of the above-described magnetic pole unit 26A1.

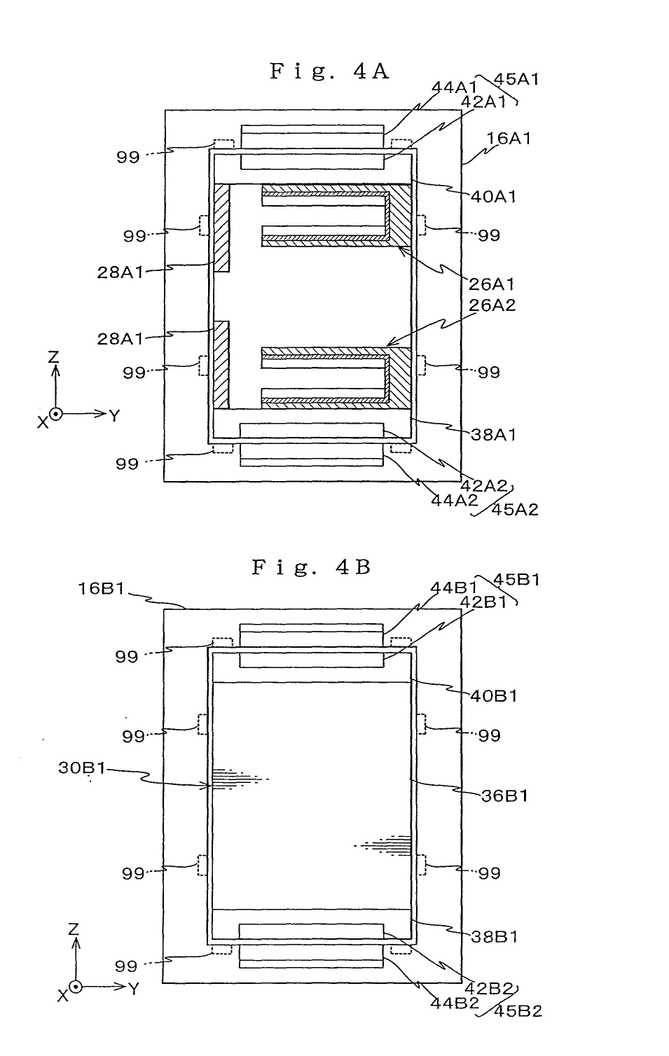

As shown in FIG. 3, the holding member 30A1 includes: (i) a fixing member 36A1 for fixing the magnetic pole units 26A1 and 26A2 and the X-axis guide members 28A1 and 28A2 in a predetermined positional relationship, and (ii) an upper face member 40A1 and a lower face member 38A1 for clamping the fixing member 36A1 from both sides in the Z-axis direction (from above and below). An armature unit 42A1 composed of armature coils arranged at predetermined intervals in the X-axis direction is embedded in the upper surface of the upper face member 40A1, as shown in FIG. 3 and FIG. 4A, which is a cross-sectional view, taken along line D-D in FIG. 2. An armature unit 42A2 similar to the armature unit 42A1 is embedded in the lower surface of the lower face member 38A1.

The other holding member 30A2 includes a fixing member 36A2, and an upper face member 40A2 and a lower face member 38A2 for clamping the fixing member 36A2 from above and below, as shown in FIG. 3.

The X-axis stationary member 18A with the above-described structure is supported in a non-contact manner by vacuum preload hydrostatic gas bearing devices (hereinafter simply referred to as “bearing devices” for convenience) 99 disposed on the inner sides (both inner sides in the Y-axis direction and both inner sides in the Z-axis direction) of the frames 16A1 and 16A2 shown in FIG. 2 (see FIG. 4A; the bearing devices disposed in the frame 16A2 are not shown). That is, while the X-axis stationary member 18A is restrained in the Y-axis direction and the Z-axis direction, it is not restrained at all in the X-axis direction. Therefore, when force in the X-axis direction acts on the X-axis stationary member 18A, the X-axis stationary member 18A moves in the X-axis direction in response to this force.

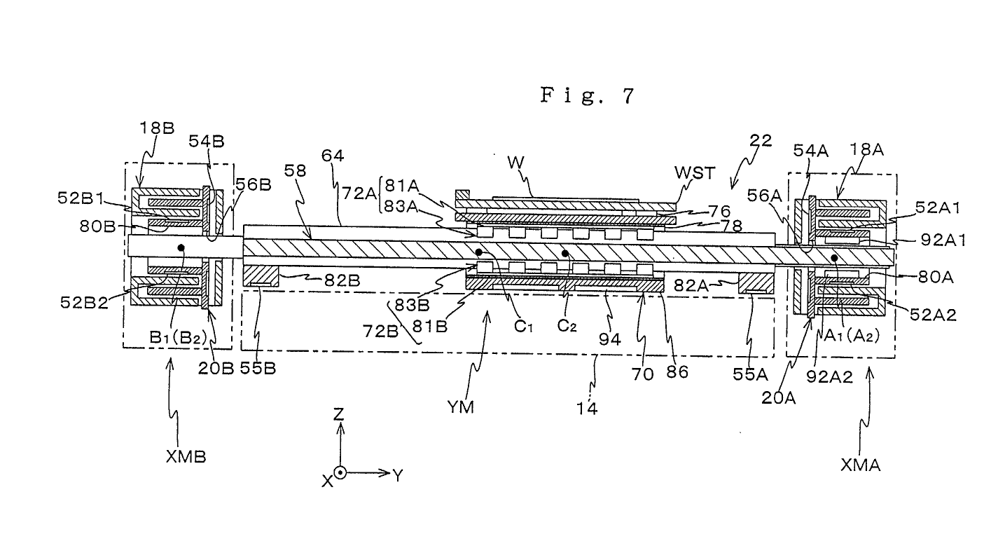

The X-axis stationary member 18A is substantially symmetric in the vertical direction with respect to its center in the Z-axis direction, as shown in FIG. 7 as a YZ cross-sectional view of the wafer stage assembly 12. For this reason, the center of gravity of the X-axis stationary member 18A in the Z-axis direction lies at a point A₁.

The X-axis moving member 20A includes, as generally shown in FIGS. 2 and 3: (a) a slide member 46A, (b) a frame member 48A, and (c) armature units 50A1 and 50A2. The slide member 46A is formed of a flat plate having a +Y-side face opposing the X-axis guide members 28A1 and 28A2. The frame member 48A has a rectangular cross section that is disposed at about the center of the +Y-side face of the slide member 46A in a space between the magnetic pole units 26A1 and 26A2 so as to extend toward the +Y side. The armature units 50A1 and 50A2 are disposed at a nearly equal distance from the frame member 48A in the ±Z-axis direction (at the positions corresponding to the inner spaces of the magnetic pole units 26A1 and 26A2) and have therein a plurality of armature coils arranged at predetermined intervals in the X-axis direction.

The −Y-side face of the slide member 46A is provided with a bearing device 54A (see FIG. 7), similar to a bearing device 54B of a slide member 46B, constituting an X-axis moving member 20B of the second X-axis motor device XMB which will be described later with reference to FIG. 3. The X-axis moving member 20A is supported in no contact with the X-axis stationary member 18A with a clearance of approximately several micrometers therebetween in the Y-axis direction by static pressure of compressed gas (for example, helium or gaseous nitrogen (or clean air)) jetted from the bearing device 54A onto the X-axis guide members 28A1 and 28A2 constituting the above-described X-axis stationary member 18A.

Similar bearing devices 52A1 and 52A2 are also disposed on the upper and lower surfaces of the frame member 48A (the bearing device 52A2 is not shown in FIG. 3, but is shown in FIG. 7). The X-axis moving member 20A is supported in no contact with the X-axis stationary member 18A with a clearance of approximately several micrometers therebetween in the Z-axis direction by static pressure of compressed gas jetted from the bearing devices 52A1 and 52A2 onto the lower surface of the magnetic pole unit 26A1 and the upper surface of the magnetic pole unit 26A2 constituting the X-axis stationary member 18A.

At the center of the slide member 46A, an opening 56A (see FIG. 7) is formed so as to be similar to an opening 56B formed in the slide member 46B constituting the X-axis moving member 20B of the second X-axis motor device XMB shown in FIG. 3, which will be described later. The opening 56A communicates with a cavity 80A of the frame member 48A.

Since the X-axis moving member 20A is substantially symmetric in the vertical direction with respect to its center in the Z-axis direction, as shown in FIG. 7, the position in the Y-axis direction and the Z-axis direction of a center of gravity A₂ thereof coincides with that of the center of gravity A₁ of the X-axis stationary member 18A.

In the first X-axis motor device XMA with the above-described structure, the X-axis moving member 20A is moved along the X-axis guide members 28A1 and 28A2 in the X-axis direction by Lorentz force produced by an electromagnetic interaction between the current passing through the armature coils of the armature units 50A1 and 50A2 and a magnetic field generated by the field magnets of the magnetic pole units 26A1 and 26A2 of the X-axis stationary member 18A. In this case, the position of the driving force (point of action of the driving force) acting on the X-axis moving member 20A in the X-axis direction coincides with the position of the center of gravity A₂ of the X-axis moving member 20A. The position in the Y-axis direction and the Z-axis direction of the reaction force (point of action of the reaction force) acting on the X-axis stationary member 18A in the X-axis direction in connection with the driving of the X-axis moving member 20A coincides with the position in the Y-axis direction and the Z-axis direction of the center of gravity A₁ of the X-axis stationary member 18A.

The amount and direction of driving force in the X-axis direction acting on the X-axis moving member 20A are controlled by the waveform (amplitude and phase) of current supplied from the main control system 21 to the armature coils of the armature units 50A1 and 50A2 via the stage control system 19.

Refrigerant (coolant) is supplied to the armature units 50A1 and 50A2 so as to cool the armature coils. The flow rate of the refrigerant is also controlled by the main control system 21.

The second X-axis motor device XMB is placed in rotational symmetry to the above-described first X-axis motor device XMA, as shown in FIG. 2, and is similarly constructed. That is, the second X-axis motor device XMB includes an X-axis stationary member 18B having a structure similar to that of the X-axis stationary member 18A of the first X-axis motor device XMA, and an X-axis moving member 20B having a structure similar to that of the X-axis moving member 20A.

The X-axis stationary member 18B includes: (i) magnetic pole units 26B1 and 26B2 similar to the above magnetic pole units 26A1 and 26A2, (ii) X-axis guide members 28B1 and 28B2 similar to the above X-axis guide members 28A1 and 28A2, and (iii) holding members 30B1 and 30B2 for holding the magnetic pole units 26B1 and 26B2 and the X-axis guide members 28B1 and 28B2 in a predetermined positional relationship.

The holding member 30B1 disposed at the +X-side end of the X-axis stationary member 18B includes: (i) a fixing member 36B1 similar to the above fixing member 36A1, and (ii) an upper face member 40B1 and a lower face member 38B1 for clamping the fixing member 36B1 from both sides in the Z-axis direction (from above and below). An armature unit 42B1 similar to the above armature unit 42A1 is embedded in the upper surface of the upper face member 40B1, and an armature unit 42B2 similar to the above armature unit 42A2 (see FIG. 4) is embedded in the lower surface of the lower face member 38B1.

The holding member 30B2 opposing the holding member 30B1 in the X-axis direction has a structure similar to that of the above holding member 30A2. That is, the holding member 30B2 includes a fixing member 36B2, and an upper face member 40B2 and a lower face member 38B2 for clamping the fixing member 36B2 from above and below.

Since the X-axis stationary member 18B has the above-described structure, the position in the Z-axis direction of its center of gravity B₁ coincides with the position in the Z-axis direction of the center of gravity A1 of the X-axis stationary member 18A.

The frames 16B1 and 16B2 are provided, on their inner sides, with bearing devices 99 in a manner similar to that of the frames 16A1 and 16A2 (see FIG. 4B).

As shown in FIG. 3, the X-axis moving member 20B includes: (a) a slide member 46B having a structure similar to that of the slide member 46A, (b) a frame member 48B disposed at about the center of the −Y-side face of the slide member 46B and having a structure similar to that of the frame member 48A, and (c) armature units 50B1 and 50B2 disposed at a nearly equal distance from the frame member 48B in the ±Z direction and having a structure similar to that of the armature units 50A1 and 50A2.

The +Y-side face of the slide member 46B is provided with a bearing device 54B, and the upper and lower faces of the frame member 48B are provided with bearing devices 52B1 and 52B2 (not shown in FIG. 3, but shown in FIG. 7) similar to the above bearing devices 52A1 and 52A2.

An opening 56B is formed in the center of the slide member 46B, as shown in FIG. 3. The opening 56B communicates with a cavity 80B of the frame member 48B (see FIG. 7).

The position in the Y-axis direction and the Z-axis direction of the center of gravity B₂ of the X-axis moving member 20B with the above-described structure coincides with the position in the Y-axis direction and the Z-axis direction of the center of gravity B₁ of the X-axis stationary member 18B, as shown in FIG. 7.

In the second X-axis motor device XMB, in a manner similar to that of the first X-axis motor device XMA, the X-axis moving member 20B is moved along the X-axis guide members 28B1 and 28B2 in the X-axis direction by Lorentz force produced by an electromagnetic interaction between current passing through the armature coils of the armature units 50B1 and 50B2 and a magnetic field generated by the field magnets of the magnetic pole units 26B1 and 26B2 of the X-axis stationary member 18B. In this case, the position of the driving force (point of action of the driving force) acting on the X-axis moving member 20B in the X-axis direction coincides with the position of the center of gravity B₂ of the X-axis moving member 20B. The position in the Y-axis direction and the Z-axis direction of the reaction force (point of action of the reaction force) acting on the X-axis stationary member 18B in the X-axis direction in connection with the driving of the X-axis moving member 20B coincides with the position in the Y-axis direction and the Z-axis direction of the center of gravity B₁ of the X-axis stationary member 18B.

In a manner similar to that of the first X-axis motor device XMA, the amount and direction of driving force in the X-axis direction acting on the X-axis moving member 20B are controlled by the waveform (amplitude and phase) of current supplied from the main control system 21 to the armature coils of the armature units 50B1 and 50B2 via the stage control system 19.

Refrigerant is supplied to the armature units 50B1 and 50B2 constituting the second X-axis motor device XMB so as to cool the armature coils, in a manner similar to that of the above armature units 50A1 and 50A2. The flow rate of the refrigerant is also controlled by the main control system 21.

In the frame 16A1 corresponding to the holding member 30A1, as shown in FIG. 4A, magnetic pole units 44A1 and 44A2, each composed of a magnetic material and a plurality of field magnets arranged at predetermined intervals in the X-axis direction, are disposed at the positions corresponding to the armature units 42A1 and 42A2 of the upper face member 40A1 and the lower face member 38A1 (that is, in the upper and lower opposing faces of the frame 16A1). In the magnetic pole units 44A1 and 44A2, pole faces of the field magnets adjacent to each other in the X-axis direction are opposite in polarity.

In the frame 16B1 corresponding to the holding member 30B1, as shown in FIG. 4B, which is a view of the holding member 30B1 and the frame 16B1, as viewed from the +X-axis direction, magnetic pole units 44B1 and 44B2, each composed of a magnetic material and a plurality of field magnets arranged at predetermined intervals in the X-axis direction, are disposed at the positions corresponding to the armature units 42B1 and 42B2 of the upper face member 40B1 and the lower face member 38B1 (that is, in the upper and lower opposing faces of the frame 16B1). In the magnetic pole units 44B1 and 44B2, pole faces of the field magnets adjacent to each other in the X-axis direction are opposite in polarity.

For this reason, an alternating magnetic field is formed in the X-axis direction in a space where the armature units 42A1 and 42A2 are placed opposed to the magnetic pole units 44A1 and 44A2. A periodic magnetic field also is formed in the X-axis direction in a space where the armature units 42B1 and 42B2 are placed opposed to the magnetic pole units 44B1 and 44B2.

As a result, the armature unit 42A1 serving as a moving member and the magnetic pole unit 44A1 serving as a stationary member constitute a linear motor 45A1, and the armature unit 42A2 serving as a moving member and the magnetic pole unit 44A2 serving as a stationary member constitute a linear motor 45A2, as shown in FIG. 4A. The armature unit 42B1 serving as a moving member and the magnetic pole unit 44B1 serving as a stationary member constitute a linear motor 45B1, and the armature unit 42B2 serving as a moving member and the magnetic pole unit 44B2 serving as a stationary member constitute a linear motor 45B2, as shown in FIG. 4B. The linear motors 45A1, 45A2, 45B1, and 45B2 generate driving force by an electromagnetic interaction.

The linear motors 45A1 and 45A2 constitute a first X-position correction device, which will be described later, and the linear motors 45B1 and 45B2 constitute a second X-position correction device. The position in the Y-axis direction and the Z-axis direction of the driving force in the X-axis direction applied from the first X-position correction device to the X-axis stationary member 18A coincides with the position in the Y-axis direction and the Z-axis direction of the center of gravity A₁ of the X-axis stationary member 18A shown in FIG. 7. The position in the Y-axis direction and the Z-axis direction of the driving force in the X-axis direction applied from the second X-position correction device to the X-axis stationary member 18B coincides with the position in the Y-axis direction and the Z-axis direction of the center of gravity B₁ of the X-axis stationary member 18B.

The amount and direction of driving force in the X-axis direction applied from the first and second X-position correction devices acting on the X-axis stationary members 18A and 18B are controlled by controlling the waveform (amplitude and phase) of current supplied from the main control system 21 to the armature coils of the armature units 42A1, 42A2, 42B1, and 42B2 via the stage control system 19.

Referring again to FIG. 2, the Y-axis motor device YM includes a Y-axis stationary member 22 and a Y-axis moving member 70.

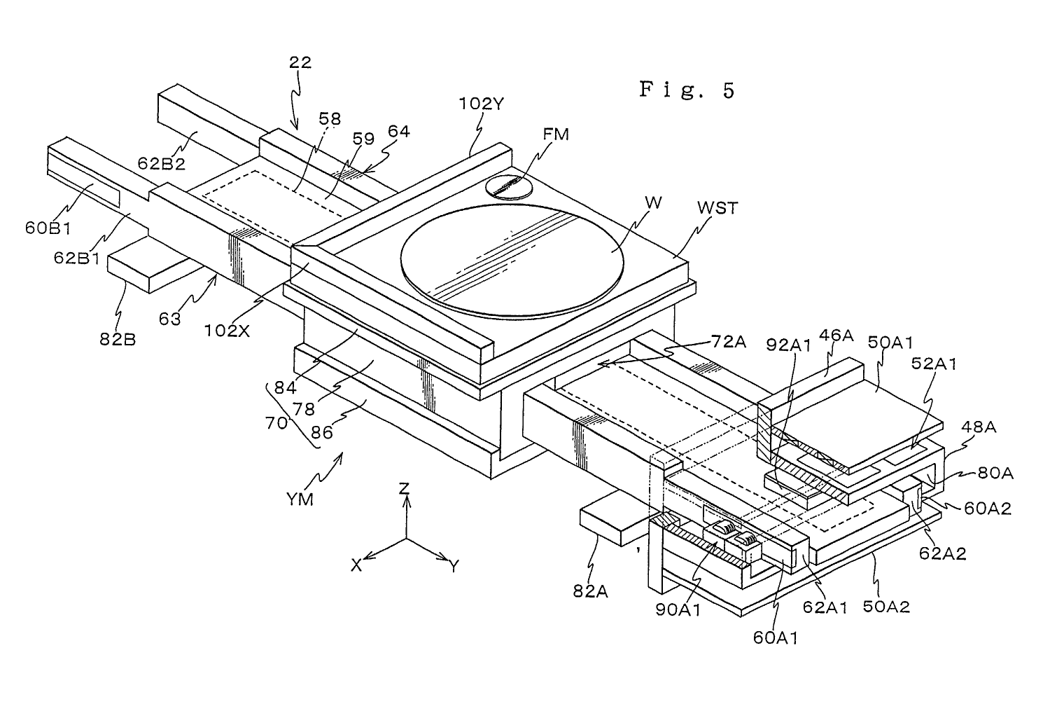

The Y-axis stationary member 22 includes, as shown in FIG. 5: (a) an armature unit 58 having therein a plurality of armature coils arranged at predetermined intervals in the Y-axis direction and extending in the Y-axis direction, (b) a housing member 59 for supporting and housing the armature unit 58, and (c) a pair of Y-axis guide members 63 and 64 disposed on both sides in the X-axis direction of the housing member 59. On the +Y-direction side, the armature coils are arranged adjacent to the +Y-side ends of the Y-axis guide members 63 and 64. In contrast, on the −Y-direction side, the ends of the Y-axis guide members 63 and 64 protrude in the −Y direction.

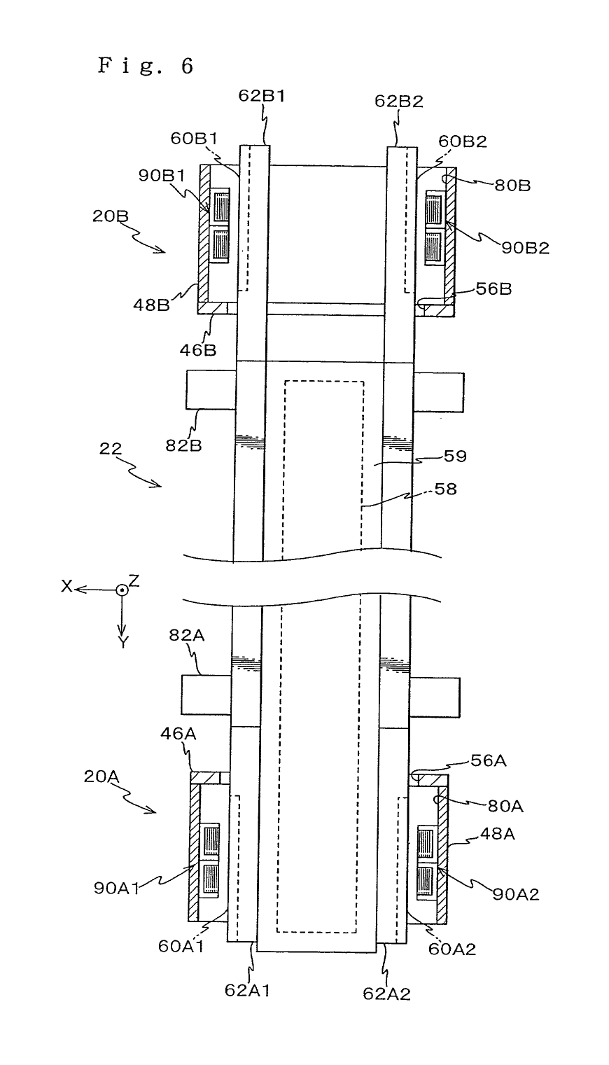

As shown in FIG. 5, the Y-axis guide member 63 has iron plate holding portions 62A1 and 62B1 on the −X-side faces at both ends in the longitudinal direction, and the Y-axis guide member 64 has iron plate holding portions 62A2 and 62B2 on the +X-side faces at both ends in the longitudinal direction. Iron plates 60A1, 60B1, 60A2, and 60B2 (the iron plate 60B2 in the iron plate holding portion 62B2 is not shown in FIG. 5, but is shown in FIG. 6) are embedded in the iron plate holding portions 62A1, 62B1, 62A2, and 62B2.

Both ends in the longitudinal direction of the Y-axis stationary member 22 are, as shown in FIG. 3, inserted in the frame members 48A and 48B via the openings 56A and 56B formed in the slide members 46A and 46B of the above-described X-axis moving members 20A and 20B.

FIG. 6 is a partly omitted cross-sectional view of the Y-axis motor device YM and the X-axis moving members 20A and 20B, taken along an X-Y plane slightly above the center in the height direction. As shown in FIG. 6, electromagnets 90A1, 90A2, 90B1, and 90B2 are fixed on the inner side walls of the frame members 48A and 48B in the X-axis moving members 20A and 20B. The electromagnets 90A1, 90A2, 90B1, and 90B2 are respectively opposed to the iron plates 60A1, 60A2, 60B1, and 60B2 embedded in the Y-axis ends of the Y-axis stationary member 22. The Y-axis stationary member 22 is restrained in the X-axis direction in a non-contact manner by magnetic force produced between the iron plates 60A1, 60A2, 60B1, and 60B2 and the electromagnets 90A1, 90A2, 90B1, and 90B2. On the other hand, since the Y-axis stationary member 22 is not restrained at all in the Y-axis direction, it can be moved in the Y-axis direction in response to force applied in the Y-axis direction. The iron plates 60A1, 60A2, 60B1, and 60B2 and the electromagnets 90A1, 90A2, 90B1, and 90B2 constitute an X-axis restraint mechanism for the Y-axis stationary member 22.

In the X-axis restraint mechanism, magnetic force between each of the electromagnets 90A1, 90A2, 90B1, and 90B2 and a corresponding iron plate is controlled by controlling current supplied to the electromagnet via the stage control system 19 by the main control system 21.

Such control of magnetic force between the iron plates 60A1, 60A2, 60B1, and 60B2 and the corresponding electromagnets 90A1, 90A2, 90B1, and 90B2 in the X-axis restraint mechanism allows the Y-axis stationary member 22 and the wafer W (the wafer stage WST) to be slightly driven in a direction θ_{Z}.

As shown in FIG. 5, placed inside the frame member 48A are: (i) a magnet 92A1 composed of a plurality of field magnets arranged at predetermined intervals in the Y-axis direction so as to be opposed to the upper surface of the armature unit 58, and (ii) a magnet 92A2 (not shown in FIG. 5, but shown in FIG. 7) composed of a plurality of field magnets arranged at predetermined intervals in the Y-axis direction so as to be opposed to the lower surface of the armature unit 58. The pole faces of the opposing field magnets in the magnets 92A1 and 92A2 are opposite in polarity. As a result, the armature unit 58 and a magnetic pole unit composed of the magnets 92A1 and 92A2 constitute a linear motor for driving the Y-axis stationary member 22 in the Y-axis direction.

The linear motor constitutes a Y-axis position correction device which will be described later. The position in the X-axis direction and the Z-axis direction of the driving force in the Y-axis direction to be given from the Y-axis position correction device to the Y-axis stationary member 22 coincides with the position in the X-axis direction and the Z-axis direction of a center of gravity C₁ of the Y-axis stationary member 22 shown in FIG. 7. The amount and direction of driving force in the Y-axis direction applied from the Y-axis position correction device and acting on the Y-axis stationary member 22 are controlled by controlling the waveform (amplitude and phase) of current supplied from the main control system 21 to the armature coils, which constitute a part of the armature unit 58 held between the magnets 92A1 and 92A2, via the stage control system 19.

Below and adjacent to both ends in the Y-axis direction of the Y-axis guide members 63 and 64, as shown in FIG. 7, floating members 82A and 82B are placed. The floating members 82A and 82B have, at their bottoms, bearing devices 55A and 55B for maintaining a clearance from the wafer surface plate 14. The floating members 82A and 82B and the Y-axis stationary member 22 are supportingly floated at a distance of approximately several micrometers from the wafer surface plate 14 by static pressure of compressed gas jetted from the bearing devices 55A and 55B onto the upper surface of the wafer surface plate 14.

In the Y-axis stationary member 22, the armature unit 58 is fixed to the portions of the Y-axis guide members 63 and 64 slightly offset downward from the center in the Z-axis direction, as is evident from the positional relationship between the armature unit 58 and the Y-axis guide member 64 which is representatively shown in FIG. 7. The position in the Z-axis direction of the center of gravity C₁ of the Y-axis stationary member 22 coincides with the position in the Z-axis direction of the center of gravity A₁ of the X-axis stationary member 18A described above.

Referring again to FIG. 5, the Y-axis moving member 70 includes: (a) a magnet holding member 78 having a rectangular XZ cross section shape, (b) a magnetic pole unit 72A placed on the upper inner surface of the magnet holding member 78 and having field magnets arranged at predetermined intervals in the Y-axis direction and a magnetic pole unit 72B (not shown in FIG. 5, but shown in FIG. 7) placed on the lower inner surface of the magnet holding member 78 and having field magnets arranged at predetermined intervals in the Y-axis direction, (c) a top plate 84 placed on the magnet holding member 78 so as to be nearly square in plan view, and (d) a center of gravity adjusting member 86 placed under the magnet holding member 78. The above-described Y-axis stationary member 22 is passed through the inner space of the magnet holding member 78.

The magnetic pole unit 72A is, as shown in FIG. 7, composed of: (i) a magnetic member 81A fixed on the upper inner surface of the magnet holding member 78, and (ii) a plurality of field magnets 83A arranged on the lower surface of the magnetic member 81A at predetermined intervals in the Y-axis direction. In this case, pole faces of the field magnets 83A face the upper surface of the armature unit 58. The pole faces of the field magnets 83A adjacent to each other in the Y-axis direction are opposite in polarity.

The magnetic pole unit 72B is composed of: (i) a magnetic member 81B fixed on the lower inner surface of the magnet holding member 78, and (ii) a plurality of field magnets 83B arranged on the upper surface of the magnetic member 81B at predetermined intervals in the Y-axis direction. In this case, pole faces of the field magnets 83B face the lower surface of the armature unit 58. The pole faces of the field magnets 83B adjacent to each other in the Y-axis direction are opposite in polarity.

The pole faces of the above-described field magnets 83A and 83B opposing in the Z-axis direction are opposite in polarity. For this reason, magnetic flux in the Z-axis direction is mainly produced between the opposing field magnets 83A and 83B. Since the pole faces of the field magnets 83A and 83B that are adjacent to each other in the Y-axis direction are opposite in polarity, as described above, an alternating magnetic field is formed in the Y-axis direction in a space between the field magnets 83A and 83B.

A plurality of bearing devices 94 are arranged on the bottom surface of the center of gravity position adjusting member 86. The Y-axis moving member 70 is supportingly floated at a distance of approximately several micrometers from the wafer surface plate 14 by static pressure of compressed gas jetted from the bearing devices 94 onto the upper surface of the wafer surface plate 14. Similarly, bearing devices (not shown) are provided on the inner faces of the magnet holding member 78 opposing in the X-axis direction, and the Y-axis moving member 70 is held in no contact with (i.e., spaced from) the outer surfaces of the Y-axis guide members 63 and 64 constituting the Y-axis stationary member 22 at a distance of approximately several micrometers therefrom. By keeping the distance fixed, the Y-axis moving member 70 and the wafer stage WST, which will be described later, are prevented from rotating (yawing) in θ_{Z} when the Y-axis moving member 70 is driven in the Y-axis direction by the Y-axis linear motor.

The pressure and flow rate of compressed gas to be jetted from the bearing devices 94 of the Y-axis moving member 70 are controlled by the stage control system 19 shown in FIG. 1 according to instructions from the main control system 21. The other bearing devices described above are also controlled in a similar manner.

As shown in FIG. 7, a Z-tilt driving mechanism 76 is placed on the upper surface of the Y-axis moving member 70 so as to control the Z-axis position and attitude (tilt) of the wafer stage WST.

The Z-tilt driving mechanism 76 is composed of three voice coil motors (not shown) that are placed at the positions on the upper surface of the top plate 84 of the Y-axis moving member 70 corresponding to the vertexes of a nearly equilateral triangle so as to support and independently and slightly drive the wafer stage WST in the Z-axis direction. Therefore, the wafer stage WST is slightly driven by the Z-tilt driving mechanism 76 in three degree-of-freedom directions, the Z-axis direction, the Ox direction (direction of rotation about the X-axis), and the θ_{Y} direction (direction of rotation about the Y-axis). Driving of the Z-tilt driving mechanism 76 is controlled by the stage control system 19 according to instructions from the main control system 21.

Since the Y-axis moving member 70 has the structure described above, the position in the X-axis direction and the Z-axis direction of a center of gravity C₂ of a composite of the Y-axis moving member 70 and the wafer stage WST coincides with the position in the X-axis direction and the Z-axis direction of the center of gravity C₁ of the Y-axis stationary member 22, as shown in FIG. 7.

In the Y-axis motor device YM with the above-described structure, the Y-axis moving member 70 is moved along the Y-axis guide members 63 and 64 in the Y-axis direction by Lorentz force produced by an electromagnetic interaction between current passing through the armature coils of the armature unit 58 and a magnetic field generated by the field magnets 83A and 83B of the magnetic pole units 72A and 72B of the Y-axis stationary member 22. In this case, the position of the driving force (point of action of the driving force) in the Y-axis direction acting on the Y-axis moving member 70 coincides with the position of the center of gravity C₂ of the Y-axis moving member 70. The position in the Y-axis direction and the Z-axis direction of the reaction force (point of action of the reaction force) in the Y-axis direction acting on the Y-axis stationary member 22 in connection with driving of the Y-axis moving member 70 coincides with the position in the X-axis direction and the Z-axis direction of the center of gravity C₁ of the Y-axis stationary member 22.

The amount and direction of driving force in the Y-axis direction acting on the Y-axis moving member 70 are controlled by controlling the waveform (amplitude and phase) of current supplied from the main control system 21 to the armature coils of the armature unit 58 via the stage control system 19.

Refrigerant for cooling the armature coils is supplied to the armature unit 58. The flow rate of the refrigerant is also controlled by the main control system 21.

An exposure operation by the exposure apparatus 100 of this embodiment with the above structure will now be described. Exposure for second and subsequent layers of a wafer W will be described as an example.

First, a reticle R is loaded onto the reticle stage RST by a reticle loader (not shown). Subsequently, reticle alignment and base line measurement are performed. During the reticle alignment and the base line measurement, the main control system 21 controls the wafer driving unit 11 via the stage control system 19 so as to move the wafer stage WST two-dimensionally. For the purpose of such two-dimensional movement of the wafer stage WST, the main control system 21 controls the waveform of current supplied to the armature units 50A1, 50A2, 50B1, and 50B2 for X-axis driving in the first and second X-axis motor devices XMA and XMB of the wafer driving unit 11 and the waveform of current supplied to the armature coils of the armature unit 58 of the Y-axis motor device YM, based on positional information (or speed information) about the wafer stage WST from the wafer interferometer 33. When driving the wafer stage WST in the X-axis direction, current is controlled so that driving forces given from the first and second X-axis motor devices XMA and XMB to the X-axis moving members 20A and 20B are equal in amount and direction.

In this case, since the X-axis moving members 20A and 20B are restrained in a non-contact manner in the Y-axis direction and the Z-axis direction, as described above, they are stably driven by the first and second X-axis motor devices XMA and XMB. Furthermore, since the centers of gravity A₂ and B₂ of the X-axis moving members 20A and 20B coincide with the driving forces acting on the X-axis moving members 20A and 20B, no torque is produced in the X-axis moving members 20A and 20B, and all the driving forces are translational in the X-axis direction. This allows the X-axis moving members 20A and 20B to be driven in the X-axis direction with high efficiency.

Since the Y-axis moving member 70 is restrained in a non-contact manner in the X-axis direction and the Z-axis direction, as described above, it is stably driven by the Y-axis motor device YM. Furthermore, since the center of gravity C₂ of the Y-axis moving member 70 and the driving force acting thereon coincide with each other, no torque is produced in the Y-axis moving member 70, and all the driving force is translational in the Y-axis direction. This allows the Y-axis moving member 70 to be driven in the Y-axis direction with high efficiency.

When the X-axis moving members 20A and 20B are driven by the first and second X-axis motor devices XMA and XMB, reaction force in a direction opposite from the driving direction of the X-axis moving members 20A and 20B is produced in the X-axis stationary members 18A and 18B. In this case, since the X-axis stationary members 18A and 18B are restrained in a non-contact manner in the Y-axis direction and the Z-axis direction, they are moved in the X-axis direction opposite from the driving direction of the X-axis moving members 20A and 20B in response to the reaction force according to the law of conservation of momentum. As a result, most of the reaction force acting on the X-axis stationary members 18A and 18B is absorbed (by their movement), rather than being transmitted to wafer surface plate 14. Consequently, it is possible to substantially completely prevent vibration from being generated due to the reaction force produced when the X-axis moving members 20A and 20B are driven.

The main control system 21 controls the waveform of current supplied to the armature coils of the armature units 42A1, 42A2, 42B1, and 42B2 for X-axis driving in the first and second X-axis position correction devices via the stage control system 19. By such control, the first and second X-axis position correction devices drive the X-axis stationary members 18A and 18B in the X-axis direction at an appropriate time so that the X-axis stationary members 18A and 18B are maintained within their stroke ranges even after being subsequently moved in the X-axis direction due to the reaction force produced by driving of the X-axis moving members 20A and 20B.

When the Y-axis moving member 70 is driven by the Y-axis motor device YM, reaction force in a direction opposite from the driving direction of the Y-axis moving member 70 is produced in the Y-axis stationary member 22. In this case, since the Y-axis stationary member 22 is restrained in a non-contact manner in the X-axis direction and the Z-axis direction, it is moved in the Y-axis direction opposite from the driving direction of the Y-axis moving member 70 in response to the reaction force according to the law of conservation of momentum. As a result, most of the reaction force acting on the Y-axis stationary member 22 is absorbed. Consequently, it is possible to substantially completely prevent vibration from being generated due to the reaction force produced when the Y-axis moving member 70 is driven.

The main control system 21 controls the waveform of current supplied to the armature coils of the armature unit 58 for Y-axis driving in the Y-axis position correction device via the stage control system 19. By such control, the Y-axis position correction device drives the Y-axis stationary member 22 in the Y-axis direction at an appropriate time so that the Y-axis stationary member 22 is maintained within its stroke range even after being subsequently moved in the Y-axis direction due to the reaction force produced by driving of the Y-axis moving member 70.

Under such control of the wafer driving unit 11 by the main control system 21, reticle alignment and base line measurement are performed while moving the wafer stage WST. When the reticle alignment and base line measurement are completed, a wafer W is loaded onto the wafer stage WST by a wafer loader (not shown). The wafer stage WST is moved to a loading position in order for the wafer W to be loaded thereon. The movement of the wafer stage WST is controlled in a manner similar to that of the above reticle alignment.

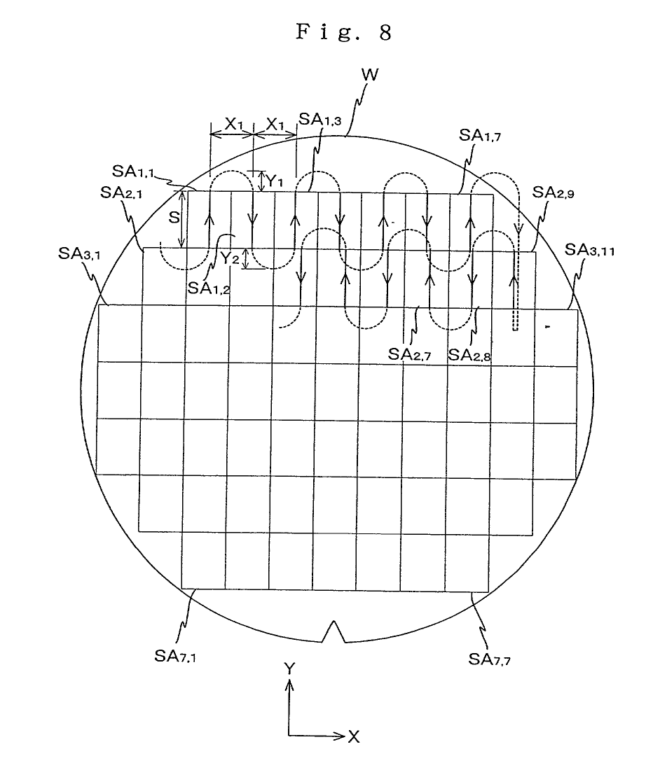

As shown in FIG. 8, a plurality of shot areas SA_{i,j} serving as areas to be exposed are arranged in a matrix on the loaded wafer W. Each of the shot areas SA_{i,j} has a chip pattern formed by exposure and development processes performed for the preceding layer, and a fine alignment mark for fine alignment.

Subsequently, fine alignment is performed by, e.g., Enhanced Global Alignment (EGA) in which the array coordinates of the shot areas SA_{i,j} on the wafer W are found by statistical calculation such as a least squares method. In the fine alignment process, the wafer stage WST is moved so that a predetermined fine alignment mark is placed in an observation area of an alignment microscope ALG when observing the fine alignment mark. The movement of the wafer stage WST is controlled in a manner similar to that of the above-described reticle alignment. Fine alignment by EGA is disclosed in, for example, Japanese Laid-Open Patent Application No. 61-44429 and U.S. Pat. No. 4,780,617 corresponding thereto.

Subsequently, exposure is effected on each shot area on the wafer W by a step-and-scan method. The shot areas SA_{i,j} are exposed in the order illustrated in FIG. 8, that is, sequentially from a shot area SA_{1,1} in the row direction (+X direction). When exposure of the last shot area SA_{1,7} of the first row is completed, exposure is then effected from the first SA_{2,9} of the second row in a row direction (−X direction) opposite from the direction of the first row. Subsequently, exposure is sequentially effected to the last shot area while reversing the direction of exposure at every linefeed.

Solid arrows in FIG. 8 show the direction of scanning for exposure areas IA in the shot areas of the wafer W. That is, this embodiment adopts a so-called alternate scanning method in which the scanning direction is sequentially reversed as exposure progresses. As the exposure of the shot areas progresses, in fact, the wafer W is moved in a direction opposite from the direction shown by the solid arrows (including dotted lines) in FIG. 8.

In such an exposure process, the main control system 21 first controls the wafer driving unit 11 via the stage control system 19 based on the result of the above fine alignment and positional information (or speed information) from the wafer interferometer 33, thereby moving the wafer stage WST so as to place the wafer W into a start position of scan-exposure for the first shot area SA_{1,1} on the wafer W. While the movement of the wafer stage WST in this case is also controlled in a manner substantially similar to that of the above reticle alignment, there are three differences as follows:

(1) At the scanning start position for the first shot area SA_{1,1}, the wafer W has a velocity component only in the −Y direction, and the velocity component is set at a predetermined value V_{W}.

(2) At the scanning start position for the first shot area SA_{1,1}, the X-axis stationary members 18A and 18B are placed in predetermined X-axis positions by the first and second X-axis position correction devices. The predetermined X-axis positions are set so as to ensure that there is sufficient space for the stroke of (i.e., the movement of) the X-axis stationary member 18A when it is moved in the +X-axis direction by reaction force produced when the wafer stage WST is moved in the −X-axis direction by a distance corresponding to one shot area of the wafer W (a distance X₁ shown in FIG. 8).

(3) At the scanning start position for the first shot area SA_{1,1}, the Y-axis stationary member 22 is placed in a predetermined Y-axis position by the Y-axis position correction device. The predetermined Y-axis position is set so as to ensure that there is sufficient space for the stroke (i.e., the movement) of the Y-axis stationary member 22 when it is moved in the +Y-axis direction by reaction force produced by the movement of the wafer stage WST during scan-exposure of the first shot area SA_{1,1} (by a distance S shown in FIG. 8) and the stepping movement thereof in the −Y-axis direction from the first shot area SA_{1,1} to the second shot area SA_{1,2} (by a distance Y₁ shown in FIG. 8) and to ensure that there is sufficient space for the stroke of the Y-axis stationary member 22 when it is moved in the −Y-axis direction by reaction force produced by the stepping movement of the wafer stage WST in the +Y-axis direction from the second shot area SA_{1,2} to the third shot area SA_{1,3} (by a distance Y₂ shown in FIG. 8).

Subsequently, the stage control system 19 starts relative movement in the Y-axis direction between the reticle R and the wafer W, that is, between the reticle stage RST and the wafer stage WST, according to directions from the main control system 21. When both the stages RST and WST reach their respective target scanning speeds and are brought into a constant-speed synchronous state, a pattern area of the reticle R starts to be illuminated with illumination light from the illumination optical system IOP, and scan-exposure is started. The above-described relative scanning is performed by controlling the reticle driving unit (not shown) and the wafer driving unit 11 by the stage control system 19 while monitoring the values measured by the wafer interferometer 33 and the reticle interferometer 15 described above.

The stage control system 19 synchronously controls the reticle stage RST and the wafer stage WST via the reticle driving unit and the wafer driving unit 11. In this case, in particular, during the above-described scan-exposure, synchronous control is executed so that the ratio of the moving velocity V_{R} of the reticle stage RST in the Y-axis direction and the moving velocity V_{W} of the wafer stage WST in the Y-axis direction is maintained in accordance with the projection magnification (¼× or ⅕×) of the projection optical system PL.

Different pattern areas on the reticle R are sequentially illuminated with light. When illumination of all the pattern areas is completed, scan-exposure of the first shot area SA_{1,1} on the wafer W is terminated. The pattern areas (i.e., the pattern) on the reticle R are thereby reduced and transferred onto the first shot area SA_{1,1} via the projection optical system PL. After the completion of scan-exposure, illumination of the pattern areas of the reticle R with the illumination light is terminated.

In the above-described synchronous movement for scan-exposure, the wafer stage WST (and the wafer W) is moved by driving the Y-axis moving member 70 by the Y-axis motor device YM in the wafer driving unit 11. During the synchronous movement, the Y-axis position of the Y-axis stationary member 22 is not corrected by the Y-axis position correction device. For this reason, reaction force produced by the driving of the Y-axis moving member 70 functions as a driving force for the Y-axis stationary member 22, which is completely freely movable according to the law of conservation of momentum, and thereby the reaction force is absorbed. As a result, it is possible to substantially completely prevent vibration due to driving of the Y-axis moving member 70 by the Y-axis motor device YM.

During the synchronous movement, of course, the driving of the wafer stage WST in the θ_{Z} direction by the X-axis restraint device, and the driving of the wafer stage WST in the Z-axis direction, the θ_{X} direction, and the θ_{Y} direction by the Z-tilt driving mechanism 76 are appropriately performed. Since the X-axis restraint device and the Z-tilt driving mechanism 76 have the structures described above, no significant variation occurs due to the driving.

When the above-described scan-exposure of the first shot area SA_{1,1} is completed, the stage control system 19 controls the wafer driving unit 11 so that the wafer stage WST is moved in a stepping manner to place the wafer W into the scanning start position of the next shot area (herein, the second shot area SA_{1,2}). Such stepping movement of the wafer W is made so as to satisfy the initial conditions of the position and speed at the completion of scan-exposure of the first shot area SA_{1,1} and the following two at-end conditions:

(1′) At the scan-exposure starting position of the second shot area SA_{1,2}, the wafer W has a velocity component only in the +Y direction, and the velocity component is set at the predetermined value V_{W}.

(2′) At the scan-exposure starting position of the second shot area SA_{1,2}, the X-axis stationary members 18A and 18B are placed into predetermined X-axis positions by the first and second X-axis position correction devices. The predetermined X-axis positions are set so as to ensure that there is sufficient room for the stroke of the X-axis stationary members 18A and 18B when they move in the +X-axis direction by reaction force produced when the wafer stage WST is moved in the −X-axis direction by a distance corresponding to one shot area of the wafer W (a distance X₁ shown in FIG. 8).

The Y-axis position of the Y-axis stationary member 22 is not corrected by the Y-axis position correction device.

Scan-exposure is effected on the second shot area SA_{1,2} in a manner similar to that of the first shot area SA_{1,1} except that the wafer W is moved in the +Y-direction.

Subsequent shot areas of the first row are sequentially scan-exposed while repeating the stepping operation and the scan-exposure operation described above.

When scan-exposure of the last shot area SA_{1,7} of the first row is completed, the stage control system 19 controls the wafer driving unit 11, according to instructions from the main control system 21, so that the wafer stage WST is moved across the rows to move the wafer W to the scan-exposure starting position for the first shot area SA_{2,9} of the second row. Such stepping movement across the rows is made so as to satisfy the initial conditions of the position and speed at the completion of scan-exposure of the shot area SA_{1,7} and the following three at-end conditions:

(1″) At the scan-exposure starting position of the shot area SA_{2,9}, the wafer W has a velocity component only in the −Y direction, and the velocity component is set at the predetermined value V_{W}.

(2″) At the scan-exposure starting position of the shot area SA_{2,9}, the X-axis stationary members 18A and 18B are placed into predetermined X-axis positions by the first and second X-axis position correction devices. The predetermined X-axis positions are set so as to ensure that there is sufficient room for the stroke of the X-axis stationary members 18A and 18B when they are moved in the −X-axis direction by reaction force produced when the wafer stage WST is moved in the +X-axis direction by a distance corresponding to one shot area of the wafer W (distance X₁).

(3″) At the scan-exposure starting position for the shot area SA_{2,9}, the Y-axis stationary member 22 is placed into a predetermined Y-axis position by the Y-axis position correction device. The predetermined Y-axis position is set so as to ensure that there is sufficient room for the stroke of the Y-axis stationary member 22 when it is moved in the +Y-axis direction by reaction force produced by the movement of the wafer stage WST during scan-exposure of the shot area SA_{2,9} and the stepping movement in the −Y-axis direction from the shot area SA_{2,9} to the next shot area SA_{2,8} and to ensure that there is sufficient room for the stroke of the Y-axis stationary member 22 when it is moved in the −Y-axis direction by reaction force produced by the stepping movement of the wafer stage WST in the +Y-axis direction from the shot area SA_{2,8} to the next shot area SA_{2,7}.

Subsequent shot areas of the second row are subjected to scan-exposure in a manner similar to that of the first row, except that scan-exposure progresses in the −X-axis direction. After that, scan-exposure is effected on the shot areas of the remaining rows (3-7) in a manner similar to that of the first and second rows.

When all the shot areas on the wafer W have been scan-exposed, the wafer W is unloaded from the wafer stage WST by an unloader (not shown). When unloading the wafer W, the wafer stage WST is moved to an unloading position. The movement of the wafer stage WST is controlled in a manner similar to that of the above-described reticle alignment. The processes for the wafer W are thereby completed.

As described above, in the exposure apparatus of the present invention, while the illumination light is being applied to the reticle R, that is, during scan-exposure, when the wafer stage WST is moved along the wafer surface plate 14, the Y-axis stationary member 22 or the X-axis stationary members 18A and 18B serving as a counter stage (countermass) are moved in a direction opposite from the moving direction of the wafer stage WST. Since most of the reaction force due to the driving of the wafer stage WST is absorbed, vibration will not be caused and exact exposure is possible. That is, exposure accuracy is not affected by vibration resulting from reaction force produced due to the driving of the wafer stage WST.

While illumination light is not applied onto the reticle R, the Y-axis position correction device and/or the first and second X-axis position correction devices appropriately correct the positions of the Y-axis stationary member 22 or the X-axis stationary members 18A and 18B so as to ensure that there is sufficient room for the stroke of the Y-axis stationary member 22 or the X-axis stationary members 18A and 18B when they are moved in subsequent operations. This shortens the total space required for the stroke of the Y-axis stationary member 22 or the X-axis stationary members 18A and 18B, and thereby prevents the exposure apparatus 100 from being of increased size.

In this embodiment, since the X-axis stationary members and the Y-axis stationary member serve as counter stages (countermasses) for absorbing the reaction force of the wafer stage, it is possible to absorb vibration resulting from the reaction force produced due to the driving of the wafer stage, without providing another counter stage (countermass) separate from the wafer stage. This allows a smaller footprint of the entire exposure apparatus. Furthermore, since the X-axis stationary members and the Y-axis stationary member serve as counter stages (countermasses), they are automatically moved in a direction opposite from the moving direction of the wafer stage by reaction force produced when the wafer stage is moved. Consequently, another driving device for the counter stages is unnecessary, and the reaction force can be easily absorbed.

The positions of the center of gravity in the Y-axis direction and the Z-axis direction of the X-axis stationary member 18A and of the X-axis moving member 20A in the first X-axis motor device coincide with positions of the points of action of the forces in the X-axis direction acting on the X-axis stationary member 18A and moving member 20A. Furthermore, the positions of the center of gravity in the Y-axis direction and the Z-axis direction of the X-axis stationary member 18B and of the X-axis moving member 20B in the second X-axis motor device coincide with positions of the points of action of the forces in the X-axis direction acting on the X-axis stationary member 18B and moving member 20B. Furthermore, the positions of the center of gravity in the X-axis direction and the Z-axis direction of the Y-axis stationary member 22 and of the Y-axis moving member 70 in the Y-axis motor device coincide with positions of the points of action of the forces in the Y-axis direction acting on the Y-axis stationary member 22 and moving member 70.

Accordingly, since during scan-exposure the moving members and the stationary members are moved only in the X-axis direction or the Y-axis direction by a combination movement therebetween according to the law of conservation of momentum, the center of gravity of a dynamic system composed of the moving members (stages) and the stationary members in combination is not displaced. Therefore, unbalanced load is not produced and high-precision position control is possible.

The shot areas are arranged in a matrix on the wafer W, and the Y-axis position of the Y-axis stationary member 22 in the Y-axis motor device is corrected by the Y-axis position correction device between the completion of exposure of a predetermined row and the start of exposure of a row next to the predetermined row. Since the position of the Y-axis stationary member 22 in the Y-axis motor device is corrected during a linefeed operation in which exposure is suspended for a relatively long period, it is possible to prevent vibration and unbalanced load from being produced due to the driving of the wafer stage WST as would occur during scan-exposure. It is also possible to reduce driving force to be applied to the Y-axis stationary member 22 at the time of correction and to thereby decrease vibration due to the driving of the Y-axis stationary member 22 to be transmitted to other sections of the exposure apparatus.

While the exposure process of the second layer and subsequent layers of the wafer has been described in this embodiment, advantages similar to those of the above embodiment can also be obtained in exposure of the first layer of the wafer that is effected in a manner similar to that of the second layer and subsequent layers, except that wafer alignment (search alignment and fine alignment) is not performed.

While the stationary members of the motor devices for moving the wafer stage WST are used to absorb reaction force of the wafer stage WST in the above embodiment, another countermass mechanism may be added.

While absorption of reaction force produced due to the driving of the wafer stage WST has been described in the above embodiment, the present invention is also applicable to the driving of the reticle stage RST for holding the reticle R. That is, the position of a counter stage (countermass), which moves in a direction opposite from the driving direction of the reticle stage RST, may be corrected to a predetermined position when exposure light is not applied. Additionally, the reticle stage may hold a plurality of reticles.

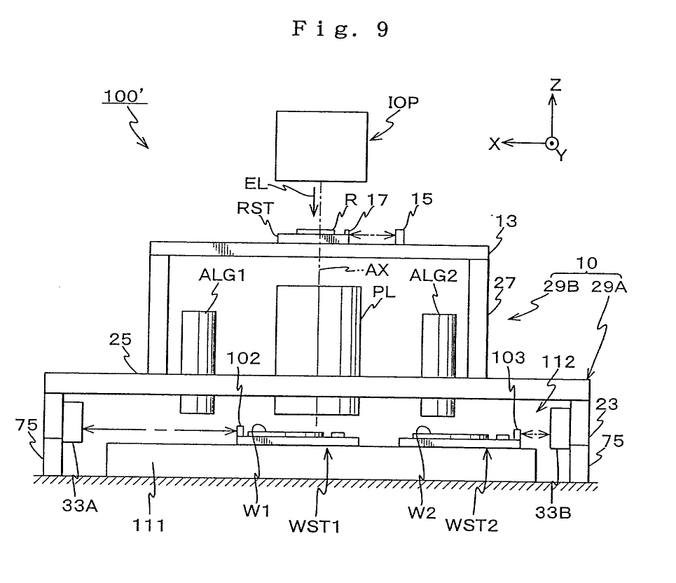

While the exposure apparatus 100 of the above embodiment has only one wafer stage WST, it may have two wafer stages. An exposure apparatus 100′ according to a modification of the above embodiment has two wafer stages WST1 and WST2, which can independently move in two dimensions, as shown in FIG. 9. In the following description of the exposure apparatus 100′, components identical or equivalent to the components of the exposure apparatus 100 are denoted by like numerals, and their repetitive explanations will also be omitted.

Referring to FIG. 9, the exposure apparatus 100′ of this modification is different from the exposure apparatus 100 shown in FIG. 1 in that it includes: (a) alignment microscopes ALG1 and ALG2 placed at equal distances from a projection optical system PL, and (b) a wafer driving unit 111 for moving the wafer stages WST1 and WST2 two-dimensionally. The wafer stages WST1 and WST2 and the wafer driving unit 111 constitute a wafer stage assembly 112 of this modification.

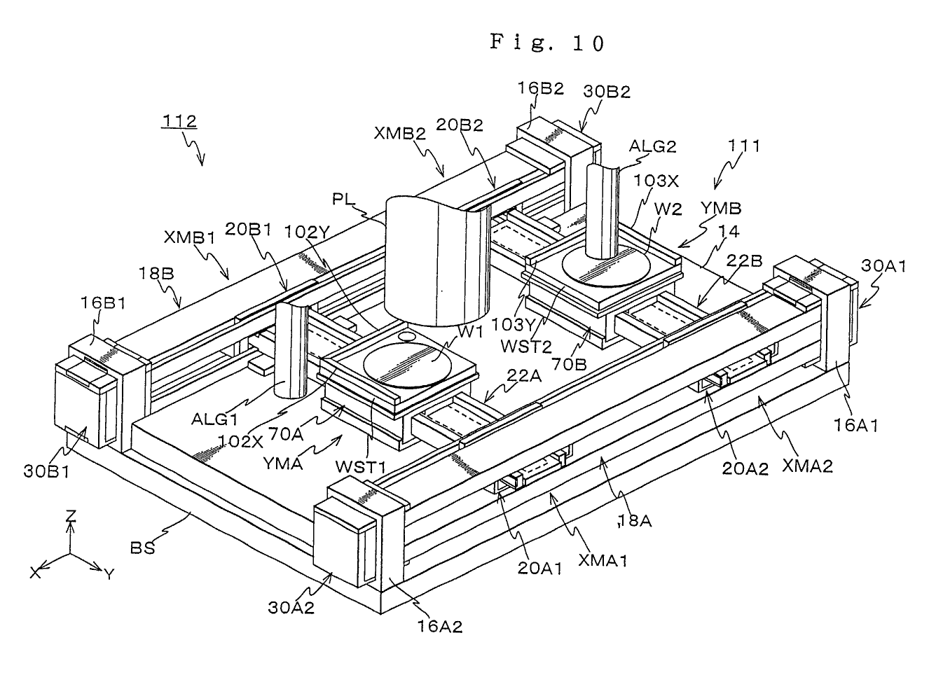

In order to detect the XY positions and the rotations about the Z-axis of the wafer stages WST1 and WST2, the exposure apparatus 100′ also includes: (c) X-axis interferometers 33A and 33B for applying an interferometric beam to X movable mirrors of the wafer stages WST1 and WST 2, and (d) three Y-axis interferometers (not shown) for applying interferometric beams, passing through the center of projection of a projection optical system PL and the centers of detection of the alignment microscopes ALG1 and ALG2, onto Y-axis movable mirrors of the wafer stages WST1 and WST2. As shown in FIG. 10, an X movable mirror 102X and a Y movable mirror 102Y are placed on the upper surface of the wafer stage WST1, and an X movable mirror 103X and a Y movable mirror 103Y are similarly placed on the upper surface of the wafer stage WST2. The movable mirrors are represented by a movable mirror 102 and a movable mirror 103 in FIG. 9.

Other sections are similar to those of the above-described exposure apparatus 100.

In the wafer driving unit 111, as shown in FIG. 10, X-axis moving members 20A1 and 20A2 similar to the above-described X-axis moving member 20A are provided for an X-axis stationary member 18A, and X-axis moving members 20B1 and 20B2 similar to the above-described X-axis moving member 20B are provided for an X-axis stationary member 18B. Furthermore, a Y-axis motor device YMA similar to the above-described Y-axis motor device YM extends between the X-axis moving members 20A1 and 20B1, and a Y-axis motor device YMB similar to the above-described Y-axis motor device YM extends between the X-axis moving members 20A2 and 20B2.

The wafer stage WST1 is placed on the upper surface of a moving member 70A of the Y-axis motor device YMA, and the wafer stage WST2 is placed on the upper surface of a moving member 70B of the Y-axis motor device YMB.

Accordingly, the wafer stage WST1 is moved in the X-axis direction by the X-axis motor device XMA1 composed of the X-axis stationary member 18A and the X-axis moving member 20A1 and the X-axis motor device XMB1 composed of the X-axis stationary member 18B and the X-axis moving member 20B1, and is moved in the Y-axis direction by the Y-axis motor device YMA composed of the Y-axis stationary member 22A and the Y-axis moving member 70A. In contrast, the wafer stage WST2 is moved in the X-axis direction by the X-axis motor device XMA2 composed of the X-axis stationary member 18A and the X-axis moving member 20A2 and the X-axis motor device XMB2 composed of the X-axis stationary member 18B and the X-axis moving member 20B2, and is moved in the Y-axis direction by the Y-axis motor device YMB composed of the Y-axis stationary member 22B and the Y-axis moving member 70B. That is, the wafer stages WST1 and WST2 are two-dimensionally moved in a manner similar to that of the above-described wafer stage WST.

In the exposure apparatus 100′ of this modification, a concurrent operation is possible, that is, while shot areas on one of the wafers W1 and W2 placed on the wafer stages WST1 and WST2, which can independently move in two dimensions, as described above, are sequentially subjected to scan-exposure similar to that in the above embodiment, the other wafer is subjected to alignment similar to that in the above embodiment.

During such a concurrent operation, for example, in a case in which the wafer stage WST2 is moved in the X-axis direction by the X-axis motor devices XMA2 and XMB2 while the wafer W1 is scan-exposed by moving the wafer stage WST1 in the Y-axis direction by the Y-axis motor device YMA, the X-axis stationary members 18A and 18B receive a reaction force in a direction opposite from the driving direction of the wafer stage WST2. As a result, if the X-axis position correction device is not operated, the X-axis stationary members 18A and 18B will move in a direction opposite to the driving direction of the stage WST2, which will cause the wafer stage WST1 to move in the X-axis direction identical to the moving direction of the X-axis stationary members 18A and 18B. This would cause the exposure accuracy for the wafer W1 to significantly deteriorate. In contrast, if the X-axis stationary members 18A and 18B are prevented from moving by operating the X-axis position correction device, absorption of reaction force (caused by X-direction movement of the stage WST2) based on the law of conservation of momentum is impossible. This causes vibration that affects the wafer stage WST1, and also deteriorates exposure accuracy for the wafer W1.

Since the Y-axis motor devices YMA and YMB have the above-described structure (i.e., they are independent from each other), the Y-axis motor device for moving one of the wafers in the Y-axis direction does not have any adverse effect, such as vibration or undesired displacement, on the other wafer. In other words, when one wafer stage (WST1 or WST2) is driven in the Y-direction, its stationary member (22A or 22B) can be permitted to move in order to absorb reaction force, and such movement will not cause the Y-direction (or X-direction) position of the other stage (WSTZ or WST1) to change.

Accordingly, in the exposure apparatus 100′ of this modification, wafer movement control is executed so that one of the wafers is not moved in the X-axis direction while the other wafer is being scan-exposed. Therefore, when exposure light EL is applied to the wafer WI, vibration resulting from the driving of the motor for moving the other wafer is not transmitted to the wafer stage WST1. This allows high-precision exposure.

Since exposure and alignment are concurrently performed in the exposure apparatus 100′ of this modification, as described above, throughput can be improved.

In this modification, movement control may be executed so that, when one of the wafers moves in the X-axis direction, the other wafer also moves in the same direction by nearly the same distance. This makes it possible to reduce the distance between the center of projection of the projection optical system PL and the center of detection of the alignment microscope ALG1 or the alignment microscope ALG2 (so as to be longer than the diameter of the wafer) and to thereby reduce the size of the exposure apparatus. Since the size of the stage surface plate 14 can also be reduced, production thereof is facilitated.

While the stage device according to the above embodiment of the invention is applied to the scanning stepper, the invention also is applicable to a stationary exposure apparatus, such as a stepper that effects exposure while a mask and a substrate are stationary. In such a case, since reaction force produced when a substrate stage for holding the substrate is driven can be absorbed, high-precision exposure is similarly possible without causing displacement of a transferred image.

The stage device of the invention is also applicable to a proximity exposure apparatus in which a pattern on a mask is transferred onto a substrate with the mask and the substrate placed in close proximity without using a projection optical system therebetween.

The invention is, of course, also applicable not only to an exposure apparatus for use in fabrication of semiconductor devices, but also to an exposure apparatus that transfers a device pattern onto a glass plate so as to produce displays, such as liquid crystal display and plasma displays, an exposure apparatus that transfers a device pattern onto a ceramic wafer so as to produce thin-film magnetic heads, and an exposure apparatus for use in producing image pickup devices, such as CCDs.

The invention is also applicable not only to microdevices such as semiconductor devices, but also to an exposure apparatus that transfers a circuit pattern onto a glass substrate, a silicon wafer, and the like in order to manufacture a reticle or a mask for use in an optical exposure apparatus, an EUV (Extreme Ultraviolet) exposure apparatus, an X-ray exposure apparatus, an electron beam exposure apparatus, and the like. In an exposure apparatus using DUV (Deep Ultraviolet) light, VUV (Vacuum Ultraviolet) light, and the like, a transmissive reticle is generally used, and a reticle substrate is made of quartz glass, quartz glass doped with fluorine, fluorite, magnesium fluoride, or quartz crystal. In the proximity exposure apparatus or the electron beam exposure apparatus, a transmissive mask (a stencil mask or a membrane mask) is used. In the EUV exposure apparatus, a reflective mask is used, and a silicon wafer or the like is used as a mask substrate.

The stage device used in the exposure apparatus of the invention is also widely applicable to other substrate processing apparatus (for example, a laser apparatus or a substrate inspection apparatus), a sample positioning device in other precision machines, and a wire bonding device.

The exposure apparatus of the invention may employ not only the projection optical system, but also a charged particle beam optical system, such as an X-ray optical system or an electron optical system. For example, the electron optical system includes an electron lens and a polarizer, and thermoelectron-emitting lanthanum hexaborite (LaB₆) or tantalum (Ta) is used as an electron gun. Of course, the optical path through which an electron beam passes is placed in a vacuum. The exposure apparatus of the invention may use, as exposure light, not only the above-described far ultraviolet light or vacuum ultraviolet light, but also soft X-ray EUV light with a wavelength of 5 nm to 30 nm.

For example, the vacuum ultraviolet light includes ArF excimer laser light and F₂ laser light. Alternatively, a harmonic wave may be used which is obtained by amplifying single-waveform laser light in an infrared region or a visible region emitted from a DFB semiconductor laser or a fiber laser by, for example, a fiber amplifier doped with erbium (or both erbium and ytterbium) and wavelength-converting the laser light into ultraviolet light by using nonlinear optical crystal.

While the projection optical system is of a reduction type in the above embodiments, it may be of a 1× (unity) magnification type or of a magnification type.

An illumination unit, a projection optical system, and the like composed of a plurality of lenses is incorporated in the main body of the exposure apparatus so as to provide for optical adjustment. Various components, such as the X-axis stationary member, the X-axis moving member, the Y-axis stationary member, the wafer stage, and the reticle stage described above, and other components, are mechanically and electrically combined and adjusted, and are subjected to total adjustment (e.g., electric adjustment and operation check), thereby producing an exposure apparatus of the invention such as the exposure apparatus 100 in the above embodiment. Preferably, the exposure apparatus is produced in a clean room in which the temperature, the level of air cleanliness, and the like are controlled.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. An exposure apparatus for transferring a pattern by irradiation of an exposure beam while moving an object along a moving plane, the exposure apparatus comprising:
a stage to hold the object;
a driver to drive the stage along the moving plane, at least part of the driver is connected to the stage;
a counter stage that moves in a direction opposite from a moving direction of the stage in response to the movement of the stage; and
a correction device to correct a position of the counter stage when the exposure beam is not applied, at least part of the correction device is connected to the counter stage.

2. An exposure apparatus according to claim 1, wherein the object is a substrate onto which the pattern is transferred, and the stage is a substrate stage.

3. An exposure apparatus according to claim 2, further comprising a plurality of the substrate stages.

4. An exposure apparatus according to claim 1, wherein the driver comprises:
a moving member connected to the stage; and
a stationary member cooperating with the moving member.

5. An exposure apparatus according to claim 4, wherein the counter stage comprises the stationary member.

6. An exposure apparatus according to claim 4, wherein a point of action of a driving force acting on the moving member, a center of gravity of the moving member, and a center of gravity of the stationary member are identical to each other in position in a direction of the normal to the moving plane.

7. An exposure apparatus according to claim 1, wherein the driver comprises:
a first driver to drive the stage in a first direction; and
a second driver to drive the stage in a second direction orthogonal to the first direction.

8. An exposure apparatus according to claim 7, wherein the object is a substrate onto which the pattern is transferred, the substrate has a plurality of exposure areas arranged in a matrix, onto each of which the pattern is transferred, and the correction device corrects the position of the counter stage between completion of exposure of an n-th row (n is a natural number) extending in the second direction and a start of exposure of an (n+1)-th row.

9. An exposure apparatus according to claim 1, wherein the object is a mask with the pattern formed thereon, and the stage is a mask stage.

10. An exposure apparatus according to claim 9, wherein the mask stage comprises a holder to hold a plurality of the masks.

11. An exposure apparatus according to claim 1, wherein the correction device includes at least one linear motor.

12. An exposure apparatus according to claim 11, wherein each of the at least one linear motors includes a movable member attached to the counter stage, and a stationary member attached to a base.

13. An exposure apparatus according to claim 12, wherein the movable member and the stationary member interact with each other electromagnetically.

14. An exposure apparatus for transferring a pattern by irradiation of an exposure beam while moving an object along a moving plane, the exposure apparatus comprising:
a stage to hold the object;
a first driver to drive the stage along the moving plane, at least part of the first driver is connected to the stage;
a counter stage that moves in a direction opposite from a moving direction of the stage in response to the movement of the stage by the first driver; and
a second driver to correct a position of the counter stage by driving the counter stage in the moving direction when the exposure beam is not applied, at least part of the second driver is connected to the counter stage.

15. An exposure apparatus according to claim 14, wherein the object is a substrate onto which the pattern is transferred, and the stage is a substrate stage.

16. An exposure apparatus according to claim 15, further comprising a plurality of the substrate stages.

17. An exposure apparatus according to claim 14, wherein the first driver comprises:
a moving member connected to the stage; and
a stationary member cooperating with the moving member.

18. An exposure apparatus according to claim 17, wherein the counter stage comprises the stationary member.

19. An exposure apparatus according to claim 17, wherein a point of action of a driving force acting on the moving member, a center of gravity of the moving member, and a center of gravity of the stationary member are identical to each other in position in a direction of the normal to the moving plane.

20. An exposure apparatus according to claim 14, wherein the object is a mask with the pattern formed thereon, and the stage is a mask stage.

21. An exposure apparatus according to claim 20, wherein the mask stage comprises a holder to hold a plurality of the masks.

22. An exposure apparatus according to claim 14, wherein the second driver includes at least one linear motor.

23. An exposure method for transferring a pattern by irradiation of an exposure beam while moving an object held on a stage along a moving plane, the exposure method comprising the steps of:
driving the stage along the moving plane;
moving a countermass in a direction opposite to a moving direction of the stage in response to the movement of the stage; and
correcting a position of the countermass while the exposure beam is not applied.

24. An exposure method according to claim 23, wherein the object is a substrate onto which the pattern is transferred.

25. An exposure method according to claim 23, wherein the stage is driven by a driver including a moving member connected to the stage and a stationary member cooperating with the moving member.

26. An exposure method according to claim 25, wherein the countermass is the stationary member.

27. An exposure method according to claim 25, wherein a point of action of a driving force acting on the moving member, a center of gravity of the moving member, and a center of gravity of the stationary member are identical to each other in position in a direction of the normal to the moving plane.

28. An exposure method according to claim 23, wherein the stage is movable in a first direction and in a second direction orthogonal to the first direction.

29. An exposure method according to claim 28, wherein the object is a substrate onto which the pattern is transferred, the substrate has a plurality of exposure areas arranged in a matrix, onto each of which the pattern is transferred, and the position of the countermass is corrected between completion of exposure of an n-th row (n is a natural number) extending in the second direction and a start of exposure of an (n+1)-th row.

30. An exposure method according to claim 23, wherein the object is a mask with the pattern formed thereon.

31. An exposure method according to claim 23, wherein the countermass is moved in a direction opposite to the moving direction of the stage by a reaction force produced when the stage is moved.

32. An exposure method according to claim 23, wherein the position of the countermass is corrected by moving the countermass with at least one linear motor.
